(19) United States
(12) Patent Application Publication
(10) Pub. No.: US 2024/0320506 A1
(43) Pub. Date: Sep. 26, 2024

(54) RETRIEVAL AUGMENTED REINFORCEMENT LEARNING

(71) Applicant: DeepMind Technologies Limited, London (GB)

(72) Inventors: Anirudh Goyal, London (GB); Andrea Banino, London (GB); Abram Luke Friesen, London (GB); Theophane Guillaume Weber, London (GB); Adrià Puigdomènech Badia, London (GB); Nan Ke, London (GB); Simon Osindero, London (GB); Timothy Paul Lillicrap, London (GB); Charles Blundell, London (GB)

(21) Appl. No.: 18/698,890

(22) PCT Filed: Oct. 5, 2022
(86) PCT No.: PCT/EP2022/077696

§ 371 Date: Apr. 5, 2024

Related U.S. Application Data
(60) Provisional application No. 63/252,603, filed on Oct. 5, 2021.

(51) Int. Cl. G06N 3/092; G06N 3/044; G06N 3/0455; G06N 3/084

(52) U.S. Cl. CPC G06N 3/092; G06N 3/044; G06N 3/0455; G06N 3/084

(57) ABSTRACT

Methods, systems, and apparatus, including computer programs encoded on computer storage media, for controlling a reinforcement learning agent in an environment to perform a task using a retrieval-augmented action selection process. One of the methods includes receiving a current observation characterizing a current state of the environment; processing an encoder network input comprising the current observation to determine a policy neural network hidden state that corresponds to the current observation; maintaining a plurality of trajectories generated as a result of the reinforcement learning agent interacting with the environment; selecting one or more trajectories from the plurality of trajectories; updating the policy neural network hidden state using update data determined from the one or more selected trajectories; and processing the updated hidden state using a policy neural network to generate a policy output that specifies an action to be performed by the agent in response to the current observation.

### CROSS-REFERENCE TO RELATED APPLICATION

This application claims priority to U.S. Provisional Application No. 63/252,603, filed on Oct. 5, 2021. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that controls an agent interacting with an environment using a retrieval-augmented action selection process.

In general, one innovative aspect of the subject matter described in this specification can be embodied in a method for controlling a reinforcement learning agent in an environment to perform a task, the method comprising: receiving a current observation characterizing a current state of the environment; processing an encoder network input comprising the current observation using an encoder neural network to determine a policy neural network hidden state that corresponds to the current observation; maintaining a plurality of trajectories generated as a result of the reinforcement learning agent interacting with the environment; selecting one or more trajectories from the plurality of trajectories, comprising, for each of one or more attention slots: applying a transition attention mechanism over the plurality of trajectories using one or more queries derived from the policy neural network hidden state that corresponds to the current observation to determine a respective trajectory attention weight for each trajectory, and selecting one or more trajectories from the plurality of trajectories using the respective trajectory attention weights; updating the policy neural network hidden state using update data determined from the one or more selected trajectories; and processing the updated hidden state using a policy neural network to generate a policy output that specifies an action to be performed by the agent in response to the current observation.

Each trajectory may comprise a sequence of transitions that each comprise a respective current observation characterizing a respective current state of the environment, and wherein the method may further comprise: for each of the one or more attention slots: applying the transition attention mechanism over the sequences of transitions included in the one or more selected trajectories using one or more queries derived from the policy neural network hidden state that corresponds to the current observation to determine a respective transition attention weight for each transition included in the one or more selected trajectories, and selecting one or more transitions from the one or more selected trajectories using the respective transition attention weights; and wherein updating the hidden state may comprise updating the hidden state using data from the one or more selected transitions.

Selecting the one or more trajectories from the plurality of trajectories using the respective trajectory attention weight may comprise: selecting a predetermined number of trajectories that have the highest trajectory attention weights among the plurality of trajectories.

The method may further comprise: generating, using a value neural network and from the hidden state that corresponds to the current observation and the data from the one or more selected trajectories, a value output that represents a value of the environment being in the current state characterized by the current observation to performing the task.

The encoder neural network may be a recurrent encoder neural network that comprises one or more recurrent neural network layers.

The encoder neural network may be part of the policy neural network.

Each attention slot may have a corresponding recurrent neural network that is configured to: receive as input the hidden state that corresponds to the current observation; process the input to determine a recurrent neural network hidden state of the recurrent neural network that corresponds to the current observation; and determine the one or more queries for the attention slot from the recurrent neural network hidden state.

The method may further comprise, when the current state of the environment characterized by the current observation is a beginning state of the environment for the task: determining, with some measure of randomness, an initial recurrent neural network hidden state for the respective recurrent neural networks for each of the attention slots.

The method may further comprise, for each transition included in each trajectory: generating, using a summarization neural network, a first encoded representation of the transition that summarizes the transition and other transitions that are before the transition in the sequence of transitions included in the trajectory; and generating, using the summarization neural network, a second encoded representation of the transition that summarizes the transition and other transitions that are after the transition in the sequence of transitions included in the trajectory.

Determining the respective trajectory attention weight for each trajectory may comprise determining the trajectory attention weight for the trajectory based on the respective transition attention weights for the transitions included in the trajectory.

Determining the respective transition attention weight for each transition included in the one or more selected trajectories may comprise, for each of the one or more recurrent neural networks: determining one or more transition keys from the first or second or both encoded representations of the transitions included in the trajectory; and applying the transition attention mechanism over the sequences of transitions included in the one or more selected trajectories using the one or more transition keys and the one or more queries to determine the respective transition attention weight for each transition included in the one or more selected trajectories.

The method may further comprise updating the respective recurrent neural network hidden state of each recurrent neural network based on determining update data from (i) the respective transition attention weight for each transition included in the one or more selected trajectories and (ii) the first or second or both encoded representations of each transition included in each trajectory.

The method may further comprise regularizing the update data using an information bottleneck.

Updating the respective recurrent neural network hidden state of each recurrent neural network may further comprise using data retrieved using a network hidden state self-attention mechanism from other network hidden states to determine the update to the respective network hidden state.

Updating the respective recurrent neural network hidden state of each recurrent neural network layer the network hidden state self-attention mechanism may comprise, for each of one or more of the recurrent neural networks: determining one or more hidden state queries from the respective network hidden state of the recurrent neural network; applying the network hidden state self-attention mechanism over the respective network hidden states of one or more recurrent neural networks using the one or more hidden state queries to determine a respective hidden state attention weight for the respective network hidden state of each of the one or more recurrent neural networks; and determining the update for the respective network hidden state of the recurrent neural network from (i) the hidden state attention weight for the respective network hidden state of each of the one or more recurrent neural networks and (ii) the respective network hidden state of each of the one or more recurrent neural networks.

Updating the hidden state using data from the one or more selected trajectories may comprise: determining an update to the hidden state from the update data, comprising applying a policy neural network hidden state attention mechanism over the update data using one or more queries derived from the hidden state.

The method may further comprise training the policy neural network through reinforcement learning.

Training the policy neural network through reinforcement learning may comprise: determining a temporal difference learning loss associated with the current observation; and determining, based on a gradient of the temporal difference learning loss computed with respect to a plurality of parameters of the policy neural network, an update to the values of the plurality of parameters of the policy neural network.

During training the encoder network input may further comprise a current action performed by the agent in response to the current observation and a reward received in response to the agent performing the current action.

The method may further comprise backpropagating the gradient of the temporal difference learning loss into the recurrent neural networks to determine an update to current values of a respective plurality of parameters of each of the one or more recurrent neural networks.

The method may further comprise: determining an auxiliary loss that is based on a quality measure of the first and second encoded representations of the transitions; and using the auxiliary loss to determine an update to current values of a plurality of parameters of the summarization neural network.

The agent may be a mechanical agent, the environment may be a real-world environment, and the observation may comprise data from one or more sensors configured to sense the real-world environment.

The reinforcement learning may be performed in a simulated environment which simulates the real world environment.

Another innovative aspect of the subject matter described in this specification can be embodied in a mechanical agent comprising a control system which performs a method according to any of the above method aspect.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The subject matter described in this specification can be implemented in particular embodiments so as to realize one or more of the following advantages. The techniques disclosed in this specification augment the agent control process that uses a policy neural network with a data retrieval process that additionally provides relevant contextual information retrieved from a replay buffer. In particular, the retrieval process uses a learned attention mechanism to dynamically access, i.e., to query for relevant contextual information from, the vast pool of past trajectories stored in the replay buffer, with the aim to integrate relevant information across these trajectories that can be used to improve the performance of the action selection neural network in computing an inference for the action selection output from a received observation. In some examples, this retrieval process can help the neural network to control the agent to achieve its task objective faster and more efficiently. In other examples, this retrieval process can help the neural network to control the agent to achieve an optimized task objective, i.e., to maximize expected rewards to be received by the agent.

The techniques disclosed in this specification also improve the training of the action selection neural network. Offline reinforcement learning (RL) training is an effective algorithm for training neural networks used in selecting actions to be performed by agents because the network can be trained without the need of controlling the agent to interact with the real-environment and can instead rely on repetitively sampling from a pre-existing corpus of training data (i.e., a memory that stores a plurality of trajectories). During training this avoids carrying out risky actions performed due to a suboptimal policy, and does not result in mechanical wear or tear or other damage to the real-world agent. Existing offline RL training typically uses some pre-programmed logic (such as prioritized experience replay) to directly select training data. In various cases, however, this data selection approach may be computationally expensive, e.g., it may take a significant number of training steps to update the parameter values of the neural network to sufficiently integrate information contained in the selected training data.

By augmenting the RL training of the policy neural network with the retrieval process, the disclosed techniques allows for training data from the memory to be utilized in a way that increases the value of the selected data during RL training. As such, the disclosed techniques can increase the speed of training of neural networks used in selecting actions to be performed by agents and reduce the amount of training data needed to effectively train those neural networks. Thus, the amount of computing resources necessary for the training of the neural networks can be reduced. For example, the amount of memory required for storing the training data can be reduced, the amount of processing resources used by the training process can be reduced, or both. The increased speed of training of neural networks can be especially significant for complex neural networks that are harder to train or for training neural networks to select actions to be performed by agents performing complex reinforcement learning tasks. From another point of view, this means that, for a given amount of computational resources employed, the success of the agent in performing a given reinforcement learning task can be improved.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for controlling a reinforcement learning agent.

FIG. 3A is an example illustration of a retrieval augmented agent control process.

FIG. 3B is an example illustration of operations included in a retrieval preprocessing stage.

FIG. 3C is an example illustration of operations included in a retrieval processing stage.

FIG. 4 is a flow diagram of an example process for determining a joint-slot update to a corresponding recurrent neural network hidden state of each recurrent neural network.

FIG. 5 is a flow diagram of an example process for training a policy neural network.

FIG. 6A is an example illustration of selecting one or more trajectories from a plurality of trajectories.

FIG. 6B is an example illustration of selecting one or more transitions from one or more selected trajectories.

FIG. 7 shows a quantitative example of the performance gains that can be achieved by using the retrieval augmented agent control process described in this specification.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary. e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment: fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design process of an entity may be optimized, e.g. by reinforcement learning, and then the optimized design output for manufacturing the entity, e.g. as computer executable instructions: an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

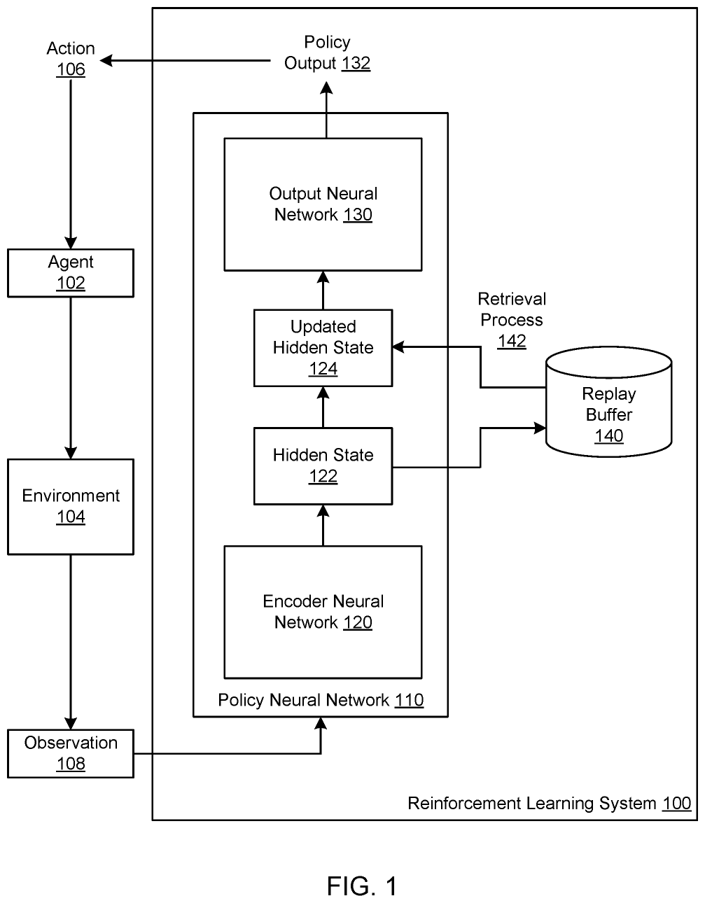

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 controls an agent 102 interacting with an environment 104 by selecting actions 106 to be performed by the agent 102 and then causing the agent 102 to perform the selected actions 106, such as by transmitting control data to the agent 102 which instructs the agent 102 to perform the action 102. In some cases, the reinforcement learning system 100 may be mounted on, or be a component of, the agent 102, and the control data is transmitted to actuator(s) of the agent.

Performance of the selected actions 106 by the agent 102 generally causes the environment 104 to transition into successive new states. By repeatedly causing the agent 102 to act in the environment 104, the system 100 can control the agent 102 to complete a specified task.

The reinforcement learning system 100 includes a policy neural network 110 which is used to control the agent 102, and a replay buffer 140 which stores trajectories generated as a consequence of the interaction of the agent 102 or another agent with the environment 104 or with another instance of the environment. Additionally or instead, the replay buffer 140 stores trajectories derived from environment interaction information obtained from any of a variety of other relevant sources, e.g., driving logs in the case of the agent being an autonomous or semi-autonomous vehicle. For example, the agent may be controlled by the present reinforcement learning system 100 or another control system, including by a human-operated or another machine learning-based control system, by a hard-coded policy that selects actions to be performed by the agent in accordance with pre-programmed logic, or simply by a random policy that selects actions with uniform randomness. Collectively, the trajectories stored in the replay butter 140 represent the past experience information of controlling the agent to perform a range of distinct tasks within similar or different environments.

Each trajectory stored in the replay buffer 140 can represent an episode of a specified task over a sequence of time steps during which the agent attempts to perform the specified task. For example, the task episode can continue for a predetermined number of time steps or until a reward is received that indicates that the task has been successfully completed. Each trajectory stored in the replay buffer 140 can include a sequence of transitions each corresponding to a respective time step. Each transition can include: (i) a respective current observation characterizing a respective current state of the environment, and, in some cases, (ii) a respective current action performed by the agent in response to the current observation, and (iii) a reward received in response to the agent performing the current action.

At a high level, the policy neural network 110 is configured to process, at each of multiple time steps, a policy network input that includes the current observation 108 characterizing the current state of the environment 104 in accordance with the learned values of the parameters of the policy neural network 110 to generate an action selection policy output (or “policy output” for brevity) 132 that can be used to select a current action 106 to be performed by the agent 102 in response to the current observation 108. Instead of processing just the current observation 108 in generating the policy output 132, the policy neural network 110 additionally uses relevant experience information retrieved from one or more trajectories 142 selected from the replay buffer 140 to assist in selecting the action 106 in response to the current observation 108.

Put another way, the reinforcement learning system 100 as described in this specification augments the action selection process, i.e., augments each inference computation of an action selection policy output 132 from a current observation 108, by using a learned retrieval process 142 to retrieve relevant experience information from the replay buffer 140 that may be useful in the current context, such as within the current environment in which the agent is deployed, for the current task that the agent is configured to perform, and the like, and subsequently processing data representing the retrieved experience information to generate the policy output 132. As used in this specification, the term “learned” means that a process or a value has been adjusted during the training of the policy neural network 110.

The policy neural network 110 includes an encoder neural network 120 and an output neural network 130. At each of multiple time steps, the policy neural network 110 uses the encoder neural network 120 to process an encoder network input that includes a current observation 108 characterizing a current state of the environment 104 in accordance with the learned values of the parameters of the encoder neural network 120 to determine a policy neural network hidden state 122 that corresponds to the current time step.

In some implementations, the encoder neural network 120 can be a feed-forward neural network, e.g., a neural network that includes one or more fully-connected layers, and/or one or more convolutional layers, that is configured to, at each of the multiple time steps, process the current observation 108 of the current time step to generate as output an encoded representation of the current observation 108, which is then used as the policy neural network hidden state 122 that corresponds to the current time step. The encoded representation of an observation can be represented as an ordered collection of numerical values, e.g., a vector or matrix of numerical values.

In other implementations, the encoder neural network 120 can be recurrent encoder neural network, e.g., a neural network that includes one or more recurrent layers, e.g., long short-term memory (LSTM) layers or gated recurrent unit (GRU) layers, arranged atop of one or more convolution layers, one or more fully connected layers, or some combination thereof, that is configured to, at each of the multiple time steps, receive the current observation 108 and update a prior policy neural network hidden state that corresponds to the previous time step by processing the current observation 108, i.e., to modify the policy neural network hidden state that has been generated by processing one or more historical observations characterizing past states of the environment by processing the current observation 108, in order to generate the policy neural network hidden state 122 that corresponds to the current time step.

The system performs a learned retrieval process 142 that uses the hidden state 122 to retrieve relevant experience information from the replay buffer 140. A computer process implemented by neural networks, the retrieval process 142 may be viewed as having two stages: (i) a retrieval preprocessing stage, which includes selecting one or more trajectories from the replay buffer 140 and then selecting one or more transitions from the one or more selected trajectories; and (ii) a retrieval processing stage, which includes generating update data that represents relevant experience information from the one or more selected transitions. As used in this specification, “relevant” experience information is information which may assist the reinforcement learning system 100 in selecting actions 106 to more effectively control the agent 102 to complete the specified task. For example, relevant experience information may include information determined from selected transitions that include observations characterizing past states of the environment which are semantically similar to the current state of the environment 104 characterized by the current observation 108.

The retrieval process 142 has one or more attention slots, each of which can be implemented as a respective group of neural networks including one or more recurrent neural networks and one or more attention neural networks. Each attention slot independently retrieves relevant experience information from the replay buffer 140, which is then used to generate the update data to be provided to and processed by the policy neural network 110 to determine an updated policy neural network hidden state 124 that corresponds to the time step, i.e., to update the policy neural network hidden state 122 using the update data generated from the retrieval process 142. To generate the update data in some implementations where there are more than one attention slots, the retrieval process 142 can use an attention neural network that operates across the relevant experience information that has been retrieved respectively by the attention slots.

Once the updated policy neural network hidden state 124 has been generated, the policy neural network 110 uses the output neural network 130 to process the updated policy neural network hidden state 124 to generate a policy output 132 for the current time step. Like the encoder neural network 120, in some implementations, the output neural network 130 can be configured as a feed-forward neural network (e.g., a neural network with one or more fully-connected layers, one or more self-attention layers, and/or one or more convolutional layers), while in some other implementations, the output neural network 130 can be configured as a recurrent neural network.

The reinforcement learning system 100 uses the policy output 132 to select the action 106 to be performed by the agent 102 at the current time step. A few examples of using the policy output 132 to select the action 106 to be performed by the agent 102 are described next.

In one example, the policy output 132 may include a respective numerical probability value for each action in a set of possible actions that can be performed by the agent. The reinforcement learning system 100 can select the action to be performed by the agent, e.g., by sampling an action in accordance with the probability values for the actions, or by selecting the action with the highest probability value.

In another example, the policy output 132 may directly define the action to be performed by the agent, e.g., by defining the values of torques that should be applied to the joints of a robotic agent.

In another example, in some cases, in order to allow for fine-grained control of the agent, the system 100 may treat the space of actions to be performed by the agent, i.e., the set of possible control inputs, as a continuous space. Such settings are referred to as continuous control settings. In these cases, the policy output 132 of the policy neural network 110 can be the parameters of a multi-variate probability distribution over the space, e.g., the means and covariances of a multi-variate Normal distribution, and the action 106 may be selected as a sample from the multi-variate probability distribution.

As yet another example, the policy output 132 may include a respective Q value for each action in the set of possible actions that can be performed by the agent 102. The system 100 can process the Q values (e.g., using a soft-max function) to generate a respective probability value for each possible action, which can be used to select the action to be performed by the agent (as described earlier). The system 100 could also select the action with the highest Q value as the action to be performed by the agent.

The Q value for an action is an estimate of a “return” that would result from the agent performing the action in response to the current observation and thereafter selecting future actions performed by the agent in accordance with the parameters of the policy neural network 110.

A return refers to a cumulative measure of “rewards” received by the agent, for example, a time-discounted sum of rewards. The agent can receive a respective reward at each time step, where the reward is specified by a scalar numerical value and characterizes, e.g., a progress of the agent towards completing an assigned task.

In some cases, the reinforcement learning system 100 can select the action to be performed by the agent in accordance with an exploration policy. For example, the exploration policy may be an ϵ-greedy exploration policy, where the system selects the action to be performed by the agent in accordance with the action selection policy output with probability 1−ϵ, and randomly selects the action with probability ϵ. In this example, ϵ is a scalar value between 0) and 1. As another example, exploration noise can be added to the action selection policy output so as to encourage action exploration. For example, the noise can be Gaussian distributed noise with an exponentially decaying magnitude.

In addition to any of the above, in some implementations, the reinforcement learning system 100 also includes a value neural network that is configured to process the updated policy neural network hidden state 124 to generate a value output that represents a value prediction of the environment 104 being in the current state to successfully performing the specified task. In other words, the value output is an estimate of the return for the specified task resulting from the environment being in the current state characterized by the current observation 108, e.g., an estimate of the time discounted sum of rewards that will be received starting from the current state over the remainder of the task episode or over some fixed number of future time steps if the agent 102 is controlled using policy outputs 132 of the policy neural network 110.

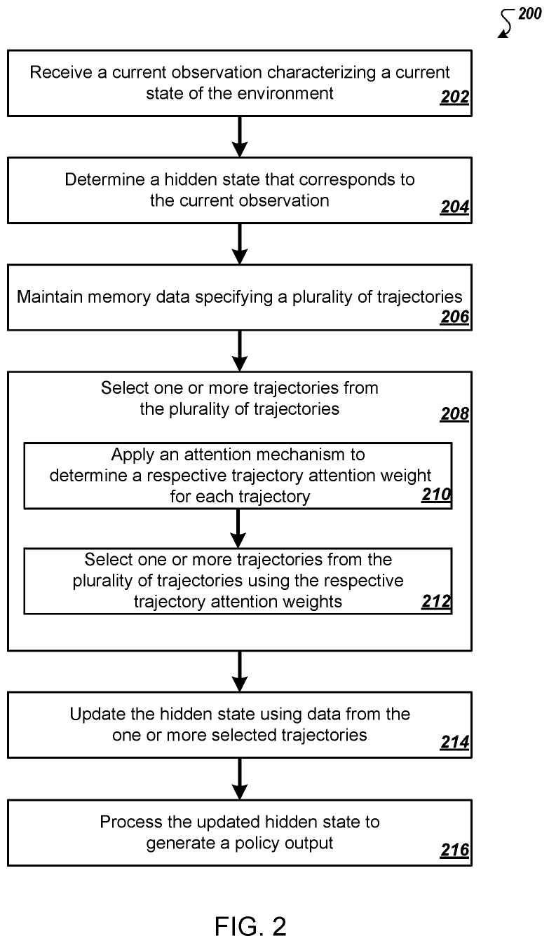

FIG. 2 is a flow diagram of an example process 200 for controlling a reinforcement learning agent in an environment to perform a task. For convenience, the process 200 will be described as being performed by a system of one or more computers located in one or more locations. For example, a reinforcement learning system, e.g., the reinforcement learning system 100 of FIG. 1, appropriately programmed, can perform the process 200.

In general the system can repeatedly perform the process 200 at each of multiple time steps to select a respective action (referred to as the “current” action below) to be performed by the agent at a respective state of the environment (referred to as the “current” state below) that corresponds to the time step (referred to as the “current” time step below).

The system receives a current observation characterizing a current state of the environment at a current time step (step 202). For example, the current observation can include an image, a video frame, an audio data segment, a sentence in a natural language, or the like. In some of these examples, the observation can also include information derived from the previous time step, e.g., the previous action performed, a reward received at the previous time step, or both.

The system processes an encoder network input that includes the current observation using an encoder neural network to determine a policy neural network hidden state that corresponds to the current observation (step 204). In some cases, the encoder network input includes just the current observation while in other cases, the encoder network input includes a sequence of observations that include the current observation characterizing the current state of the environment and one or more historical observations characterizing past states of the environment that precede the current state of the environment.

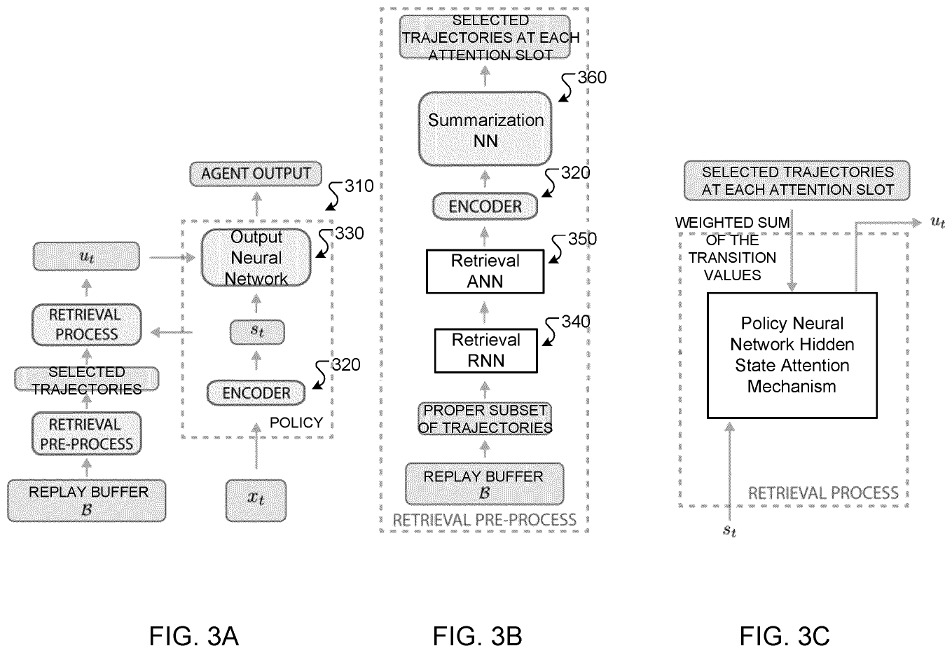

FIG. 3A is an example illustration of a retrieval augmented agent control process. As illustrated, the encoder neural network 320, which is implemented as part of the policy neural network 310, processes an encoder network input that includes the current observation xₜ (where t is an integer index labelling the current time step) in accordance the learned values of the parameters of the encoder neural network to generate, as an intermediate output of the policy neural network, a policy neural network hidden state sₜ that corresponds to the current observation xₜ:

The system maintains a plurality of trajectories generated as a result of the reinforcement learning agent or another agent interacting with the environment or with another instance of the environment (step 206). Each trajectory can include a sequence of transitions. Each transition can include: (i) a respective current observation characterizing a respective current state of the environment, and, in some cases, (ii) a respective current action performed by the agent in response to the current observation, (iii) a reward received in response to the agent performing the current action, or both.

While in some cases the plurality of trajectories maintained by the system at step 206 can correspond to all of the trajectories stored in the replay buffer B, in other cases, the plurality of trajectories can instead correspond to a proper subset of trajectories that has been sampled, e.g., through uniform randomness, from all of the trajectories stored in the replay buffer B. Overall computational complexity may be reduced in those other cases, because the number of sampled proper subset of trajectories is smaller than the total number of trajectories stored in the replay buffer B.

The system selects one or more trajectories from the plurality of trajectories (step 208). This selection may be referred to as a retrieval preprocessing stage.

FIG. 3B is an example illustration of operations included in the retrieval preprocessing stage. As discussed above, in some implementations, the retrieval process (which may be viewed as a retrieval preprocessing stage followed by a retrieval processing stage) has multiple attention slots, and the system can perform some of the operations of the retrieval preprocessing stage, e.g., in parallel and independently from another attention slot, at each attention slot to select one or more respective transitions, which are then used at the retrieval processing stage to generate the update data uₜ that represents the relevant experience information at each attention slot for collectively updating the policy neural network hidden state sₜ that corresponds to the current observation xₜ. In some other implementations, the retrieval process includes only a single attention slot and therefore only performs these operations once to select the one or more trajectories, which are then used at the retrieval processing stage to generate the update data uₜ that represents the relevant experience information for updating the policy neural network hidden state sₜ.

As illustrated in FIG. 3B, each of the one or more attention slots has a retrieval recurrent neural network (RNN) 340, a retrieval attention neural network (ANN) 350, and a summarization neural network 360. The summarization neural network 360 can be configured as either a bi-directional recurrent neural network or an attention neural network.

The retrieval RNN 340 receives as input the policy neural network hidden state sₜ that corresponds to the current observation xₜ, and processes the input to update a prior retrieval RNN hidden state (a prior recurrent neural network hidden state) mₜ₋₁ that corresponds to the prior policy neural network hidden state Sₜ₋₁ (that in turn corresponds to the historical observation xₜ₋₁ characterizing the past state of the environment) by processing the policy neural network hidden state sₜ that corresponds to the current observation xₜ, in order to generate the retrieval RNN hidden state (a recurrent neural network hidden state) \hat{m}ₜ₋₁ that corresponds to the current observation xₜ.

When the current state of the environment characterized by the current observation is a beginning state of the environment for the task, i.e., at t=0, the retrieval RNN hidden state is an initial hidden state which can, for example, be determined with some measure of randomness (e.g. a known random number generation algorithm).

Once the retrieval RNN hidden state \hat{m}ₜ₋₁ has been generated, the system can use the retrieval RNN hidden state \hat{m}ₜ₋₁ to determine one or more transition queries for the attention slot from the retrieval RNN hidden state. In some implementations, this can include applying a sequence of one or more learned transformations, e.g., one or more linear or non-linear transformations, to the retrieval RNN hidden state.

For each transition included in each trajectory in the plurality of trajectories, the system uses the summarization neural network 360 to generate a first encoded representation (which may be denoted hₜ) and a second encoded representation (which may be denoted bₜ). The first encoded representation corresponds to the “forward” summary of the transition that summarizes (i.e., captures information about) the transition and other transitions that are before the transition in the sequence of transitions included in the trajectory. The second encoded representation corresponds to “backward” summary of the transition that summarizes the transition and other transitions that are after the transition in the sequence of transitions included in the trajectory.

To generate the first (or the second) encoded representation of each transition in a given trajectory, the summarization neural network 360 processes the policy neural network hidden states that correspond respectively to the historical observations up to the current observation xₜ (or the policy neural network hidden states that correspond respectively to the future observations beginning from the current observation xₜ) that have been determined by the encoder neural network 320 from processing the observations included in the given trajectory.

Once the first and second encoded representations have been generated, the system can use the first and second encoded representations to determine one or more transition keys and one or more transition values for each transition in a given trajectory for the attention slot from the first and second encoded representations. Like how the one or more transition queries are determined from the retrieval RNN hidden states, the transition keys or transition values can be determined by applying a sequence of one or more learned transformations to the first encoded representation, second encoded representation, or both. In some implementations, the transition keys can be determined by applying a sequence of one or more learned transformations to the first encoded representation for each transition in a given trajectory, while the transition values can be determined by applying a sequence of one or more learned transformations to the second encoded representation for each transition in the given trajectory. The sequence of one or more transformations used to generate the transition keys can be different from the sequence of one or more transformations used to generate the transition values, and both can be different from that used to generate the transition queries.

The system uses the retrieval attention neural network (ANN) 350 to apply a transition attention mechanism over the plurality of trajectories using the transition keys and transition queries to determine a respective trajectory attention weight for each trajectory in the plurality of trajectories (step 210). As used herein an attention neural network is a neural network having one or more attention layers which include an attention mechanism (referred to as the “transition attention mechanism”), for example a scaled dot-product attention mechanism. In particular, the system first uses the transition attention mechanism to obtain a respective transition attention weight for each transition included in each of the plurality of trajectories, and then uses the respective transition attention weights to determine the trajectory attention weight for each trajectory.

In scaled dot-product attention, for a given transition query, the attention layer computes the dot products of the transition query with all of the transition keys, divides each of the dot products by a scaling factor, e.g., by the square root of the dimensions of the transition queries and transition keys, and then applies a softmax function over the scaled dot products to obtain the transition attention weights on the transitions. For each trajectory in the plurality of trajectories, the transition attention weight on each transition included therein can then be combined, e.g., summed or averaged, to provide the trajectory attention weight for the trajectory.

The system selects one or more trajectories from the plurality of trajectories using the respective trajectory attention weights (step 212). In some implementations, this can include selecting a predetermined number of trajectories that have the highest trajectory attention weights among the plurality of trajectories. In some implementations, the trajectory attention weights are normalized across all trajectories, and this selection is based on the normalized trajectory attention weights.

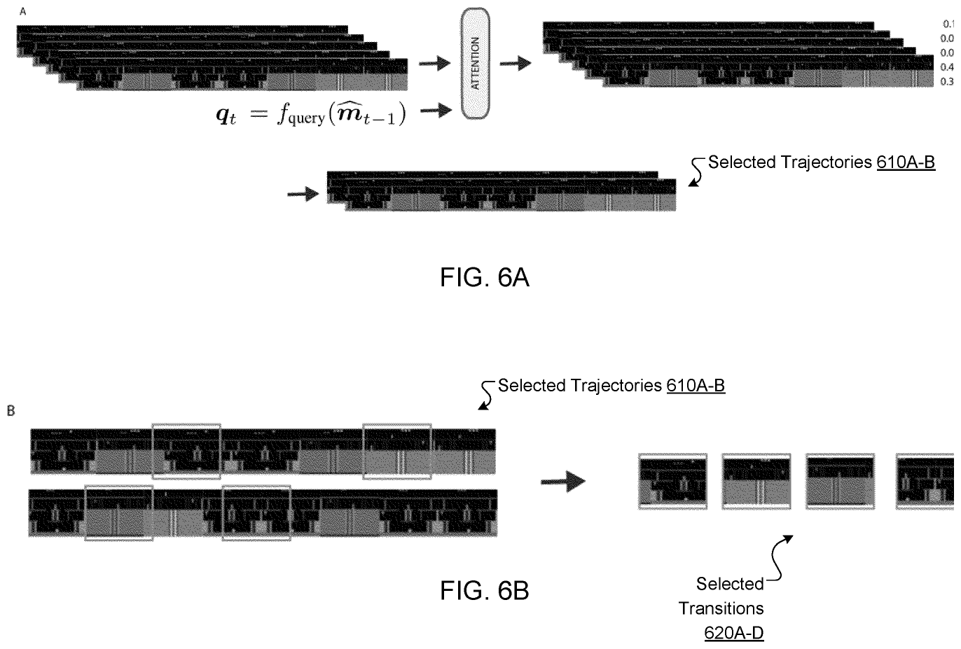

FIG. 6A is an example illustration of selecting one or more trajectories from a plurality of trajectories. As illustrated, the system selects two trajectories 610A-B having the highest trajectory attention weights (0.45 and 0.35) among a total of five trajectories (that have trajectory attention weights of 0.1, 0.05, 0.05, 0.45, and 0.35, respectively).

From each of the one or more selected trajectories, the system, using the transition attention mechanism, selects one or more transitions from the selected trajectory. The system can make this selection based on the transition attention weight on each transition included in each selected trajectory. In a similar manner, in some implementations, this can include selecting a predetermined number of transitions that have the highest transition attention weights among the plurality of transitions included in each selected trajectory.

FIG. 6B is an example illustration of selecting one or more transitions from one or more selected trajectories. As illustrated, the system selects two transitions having the highest transition attention weights 620A-D from each of the two trajectories 610A-B selected in the example of FIG. 6A.

Note that in principle a different attention mechanism might be used to select the trajectories (in which case it might be called a “trajectory attention mechanism”) from the attention mechanism used to select the transition. However, preferably the same transition attention mechanism is used for both tasks.

The system then proceeds to generate the update data uₜ from the one or more selected transitions of the one or more selected trajectories at each of the one or more attention slots. This may be referred to as a retrieval processing stage.

FIG. 3C is an example illustration of operations included in the retrieval processing stage. In the retrieval processing stage for implementations that include multiple attention slots, the system computes a weighted sum of the transition values that have been determined for the selected transitions at each attention slot, weighted by the transition attention weights on the selected transitions. The weighted sum of transition values will then be used to generate the update data uₜ by using an attention mechanism (referred to as a “policy neural network hidden state attention mechanism”). In the retrieval processing stage for implementations that include a single attention slot, the system uses the weighted sum of the transition values that have been determined for the selected transitions at the single attention slot as the update data uₜ.

In some implementations, this weighted sum of transition values can be regularized prior to being used to generate the update data uₜ, by way of using information bottleneck techniques, e.g., one of the techniques described in more detail in Galashov. A. et al., Information asymmetry in KL-regularized RL, arXiv: 1905.01240, to reduce the dependence of the action selection process on the retrieval process. Applying information bottleneck may be interpreted as encouraging the policy neural network to learn useful behaviors and follow those behaviors closely, except where diverting from doing so (as a result of using the update data generated from the retrieval process) leads to higher reward being received by the agent.

The policy neural network hidden state attention mechanism can be implemented by using an attention neural network that includes one or more attention layers having an attention mechanism similar to the transition attention mechanism discussed above.

To apply the policy neural network hidden state attention mechanism, the system determines one or more policy neural network hidden state queries from the policy neural network hidden state sₜ of the policy neural network hidden state. The system also determines one or more policy neural network hidden state keys and one or more policy neural network hidden state values for the (regularized) weighted sum of the transition values at each attention slot. In particular, the system can apply a sequence of one or more learned transformations to the policy neural network hidden state to generate the policy neural network hidden state queries; apply a sequence of one or more learned transformations to the (regularized) weighted sum of the transition values at each attention slot to generate the policy neural network hidden state keys, and apply a sequence of one or more learned transformations to the (regularized) weighted sum of the transition values at each attention slot to generate the policy neural network hidden state values.

The policy neural network hidden state attention mechanism maps a network hidden state query and a set of network hidden state key-value pairs to the update data uₜ. The update data uₜ is computed as a weighted sum of the network hidden state values, where the weight assigned to each network hidden state value is computed by a compatibility function of the policy neural network hidden state query with the corresponding policy neural network hidden state key. In scaled dot-product attention, for a given policy neural network hidden state query, the attention layer computes the dot products of the policy neural network hidden state query with all of the policy neural network hidden state keys, divides each of the dot products by a scaling factor, e.g., by the square root of the dimensions of the policy neural network hidden state queries and policy neural network hidden state keys, and then applies a softmax function over the scaled dot products to obtain the weights on the policy neural network hidden state values. The attention layer then computes as output (the update data uₜ) a weighted sum of the policy neural network hidden state values in accordance with these weights.

The system updates the policy neural network hidden state sₜ using the update data uₜ that has been determined from the one or more selected transitions of the one or more selected trajectories (step 214). In some implementations, determining the updated policy neural network hidden state \tilde{s}ₜ can include combining, e.g., adding, the update data uₜ to the policy neural network hidden state sₜ.

The system processes the updated hidden state sₜ using an output neural network of the policy neural network to generate a policy output that specifies an action to be performed by the agent in response to the current observation (step 216). To cause the agent to perform the specified action, the system can for example pass an instruction or other control signal to a control system for the agent.

In some implementations, the weighted sum of transition values is also used to update the retrieval RNN hidden state (the recurrent neural network hidden state) \hat{m}ₜ₋₁ of the retrieval RNN 340 that corresponds to the current observation xₜ. When the retrieval process has a single attention slot having one single retrieval RNN, the update can include just a slot-wise update to the retrieval RNN hidden state that can be performed by computing a sum of the weighted sum of transition values and the retrieval RNN hidden state of the retrieval RNN (where the slot-wise updated retrieval RNN hidden state may be denoted \tilde{m}ₜ).

Additionally, in these implementations, when retrieval process has multiple attention slots each having their own retrieval RNNs, the system further uses data retrieved using an attention mechanism (referred to as a “network hidden state self-attention mechanism”) from other retrieval RNN hidden states to determine a joint-slot update to the retrieval RNN hidden state of each retrieval RNN, i.e., in addition to the slot-wise update. The network hidden state self-attention mechanism can be implemented by using an attention neural network that includes one or more attention layers having an attention mechanism similar to the transition attention mechanism discussed above.

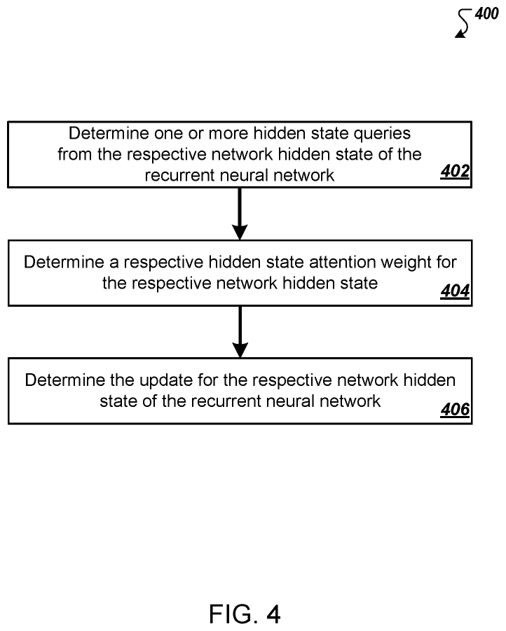

FIG. 4 is a flow diagram of an example process for determining a joint-slot update to a corresponding RNN hidden state of each retrieval RNN. For convenience, the process 400 will be described as being performed by a system of one or more computers located in one or more locations. For example, a reinforcement learning system, e.g., the reinforcement learning system 100 of FIG. 1, appropriately programmed, can perform the process 400. In general, the system can perform the process 400 for each of the multiple retrieval recurrent neural networks (RNNs).

The system determines one or more retrieval RNN hidden state queries from the retrieval RNN hidden state of the retrieval RNN (step 402). The system also determines one or more retrieval RNN hidden state keys and one or more retrieval RNN hidden state values for the retrieval RNN hidden state of each retrieval RNN of the multiple retrieval RNNs. The system can apply a sequence of one or more learned transformations to the retrieval RNN hidden state to generate the retrieval RNN hidden state queries; apply a sequence of one or more learned transformations to the retrieval RNN hidden state of each of the multiple retrieval RNNs to generate the retrieval RNN hidden state keys; and apply a sequence of one or more learned transformations to the retrieval RNN hidden state of each of the multiple retrieval RNNs to generate the retrieval RNN hidden state values. In some implementations, the retrieval RNN hidden state queries can be determined from the retrieval RNN hidden state \hat{m}ₜ₋₁ before the slot-wise update, i.e., before the weighted sum of transition values is added to retrieval RNN hidden state, while the retrieval RNN hidden state keys and the retrieval RNN hidden state values can be determined from the retrieval RNN hidden state \tilde{m}ₜ of each of the multiple retrieval RNNs after the slot-wise update, i.e., after the weighted sum of transition values is added to the retrieval RNN hidden state.

The system applies the network hidden state self-attention mechanism over the respective retrieval RNN hidden states of multiple retrieval RNNs using the one or more retrieval RNN hidden state queries (step 404).

The network hidden state self-attention, which can for example be implemented as a scaled dot-product attention mechanism, maps a retrieval RNN hidden state query and a set of retrieval RNN hidden state key-value pairs to an output. The output is computed as a weighted sum of the retrieval RNN hidden state values, where the weight assigned to each retrieval RNN hidden state value is computed by a compatibility function of the retrieval RNN hidden state query with the corresponding retrieval RNN hidden state key. In scaled dot-product attention, for a given retrieval RNN hidden state query, the attention layer computes the dot products of the retrieval RNN hidden state query with all of the retrieval RNN hidden state keys, divides each of the dot products by a scaling factor, e.g., by the square root of the dimensions of the retrieval RNN hidden state queries and retrieval RNN hidden state keys, and then applies a softmax function over the scaled dot products to obtain the weights on the retrieval RNN hidden state values. The attention layer then computes a weighted sum of the retrieval RNN hidden state values in accordance with these weights. Thus, for scaled dot-product attention the compatibility function is the dot product and the output of the compatibility function is further scaled by the scaling factor.

The system uses the output of the network hidden state self-attention to determine the joint-slot update to the retrieval RNN hidden state of the retrieval RNN (step 406). In some implementations, this can include combining, e.g., adding, the weighted sum of the retrieval RNN hidden state values to the slot-wise updated retrieval RNN hidden state (where the slot-wise and joint-slot updated retrieval RNN hidden state may be denoted mₜ).

Processes 200 and 400 may be represented by the example algorithm shown below.
Step 1: Compute the query. For all 1≤k≤n_{f}, compute

$${\hat{m}}_{t - 1}^{k} = G R {U}_{θ} ( {s}_{t} , {m}_{t - 1}^{k} )$$

$${q}_{t}^{k} = {f}_{query} ( {\hat{m}}_{t - 1}^{k} )$$

Step 2: Identify the most relevant trajectories. For all 1≤k≤n_{f}, 1≤j≤l and 1≤i≤nₜᵣₐⱼ.

$${κ}_{i , j} = {( {h}_{j}^{i} {W}_{ret}^{e} )}^{T}$$

$${ℓ}_{i , {j}^{=}}^{k} ( \frac{{q}_{t}^{k} {κ}_{i , j}}{\sqrt{{d}_{e}}} )$$

$${α}_{𝔦 , j}^{k} = softmax ( {ℓ}_{i , j}^{k} ) .$$

Given scores α, the top-kₜᵣₐⱼ trajectories (resp. top-kₛₜₐₜₑₛ states) are selected and denoted by [symbol] (resp. Sₜ^{k}).
Step 3: Retrieve information from the most relevant trajectories and states.

α_{i,j}^{k}=softmax( [symbol] ),i∈ [symbol] ,j∈Sₜ^{k}.

gₜ^{k}=Σ_{i,j}α_{i,j}^{k}v_{i,j} where v_{i,j}=b_{i,j}Wᵣₑₜ^{v}
Step 4: Regularize the retrieved information by using information bottleneck.

zₜ^{k}˜p(z|gₜ^{k})
Step 5: Update the states of the slots.
   Slotwise update using retrieved information:

$${\tilde{m}}_{t}^{k} ← {\hat{m}}_{t - 1}^{k} + {z}_{t}^{k} \qquad ∀ k ∈ \{ 1 , … , {n}_{f} \}$$

Joint slot update through self-attention:

$${c}_{t}^{k} = {\hat{m}}_{t - 1}^{k} {W}_{SA}^{q} \qquad ∀ k \{ 1 , … , {n}_{f} \}$$

$${β}_{k , {k}^{′}} = {softmax}_{{k}^{′}} ( \frac{{c}_{t}^{k} {κ}_{t}^{{k}^{′}}}{\sqrt{{d}_{e}}} ) \qquad where {κ}_{t}^{{k}^{′}} = {( {\tilde{m}}_{t}^{{k}^{′}} {W}_{SA}^{e} )}^{T} \qquad ∀ k , {k}^{′} ∈ \{ 1 , … , {n}_{f} \}$$

$${m}_{t}^{k} ← {\tilde{m}}_{t}^{k} + {\sum }_{{k}^{′}} {β}_{k , {k}^{′}} {v}_{{k}^{′}} \qquad where {v}_{{k}^{′}} = {\tilde{m}}_{t}^{k} {W}_{S A}^{υ} \qquad ∀ k ∈ \{ 1 , … , {n}_{f} \}$$

Step 6: Update the agent state using the retrieved information.

$${d}_{t} = {s}_{t} {W}_{ag}^{q}$$

$${κ}^{k} = {( {z}_{t}^{k} {W}_{ag}^{e} )}^{T} \qquad ∀ k ∈ \{ 1 , … , {n}_{f} \}$$

$${γ}_{k} = {softmax}_{k} ( \frac{{d}_{t} {κ}^{k}}{\sqrt{{d}_{e}}} )$$

$$\begin{matrix}{u}_{t} ← {\sum }_{k} {γ}_{k} {v}_{k} & where {v}_{k} = {z}_{t}^{k} {W}_{a g}^{υ} & ∀ k ∈ \{ 1 , … , {n}_{f} \} .\end{matrix}$$

$${\tilde{s}}_{t} ← {s}_{t} + {u}_{t}$$

In the example algorithm shown above, k is the number of attention slots, l is the number of time steps (or transitions) in one trajectory of the total of nₜᵣₐⱼ trajectories, θ denotes the encoder neural network which generates a policy neural network hidden state sₜ from the current observation xₜ, k, q, v are the keys, queries, and values (where each key, query, and value may be a vector) used in the attention mechanisms, and W is the parameters that define the transformations used in the attention mechanisms to generate the keys, queries, and values.

Referring back to FIG. 1, to allow the agent 102 to effectively perform the specified task by interacting with the environment 104, the reinforcement learning system 100 can include a training engine that trains the policy neural network 110 to determine trained values of the parameters of the policy neural network 110. In other words, not only can the process 200 be performed as part of generating a policy output for a current observation for which the desired action, i.e., the action that could result in successful completion of the task, but the process 200 can also be performed as part of an online or offline RL training process to train the policy neural network based on agent interaction with the environment.

The training process also includes jointly updating the retrieval process. During training, the retrieval process can also improve the training of the policy neural network by providing the network with relevant information retrieved from the transitions stored in the memory that can result in more effective parameter updates, e.g., compared with a conventional offline RL training technique such as a prioritized experience replay technique.

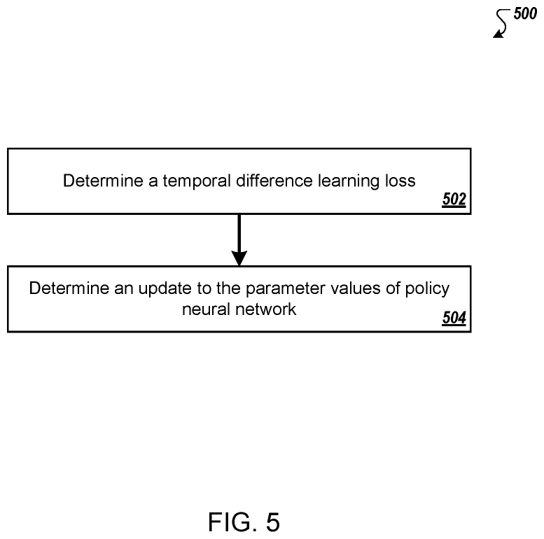

FIG. 5 is a flow diagram of an example process 500 for training a policy neural network through reinforcement learning. For convenience, the process 500 will be described as being performed by a system of one or more computers located in one or more locations. For example, a reinforcement learning system, e.g., the reinforcement learning system 100 of FIG. 1, appropriately programmed, can perform the process 500.

The system processes an encoder network input that includes a current observation characterizing a current state of the environment, and determines a reinforcement learning (RL) loss, e.g., a temporal difference learning loss, associated with the current observation (step 502). In some implementations, during training the encoder network input also includes a current action performed by the agent in response to the current observation and a reward received in response to the agent performing the current action.

Generally the temporal difference learning loss can be determined by evaluating any RL objective function that is appropriate for the task that the agent is configured to perform. For example, the temporal difference learning loss can be determined based on one of the policy-based RL algorithms described in Kapturowski, S., et al., Recurrent experience replay in distributed reinforcement learning. In International conference on learning representations, 2018 and Mnih, V., at al. Human-level control through deep reinforcement learning. Nature 518, 529-533 (2015).

The system determines, based on a gradient of the temporal difference learning loss computed with respect to the parameters of the policy neural network, one or more updates to the values of the plurality of parameters of the policy neural network to train policy neural network to optimize the temporal difference learning loss (step 504).

The system also determines, by virtue of backpropagating the gradient of the temporal difference learning loss into the recurrent neural networks, one or more updates to current values of the parameters of each of the one or more retrieval recurrent neural networks. Through backpropagation the system similarly determines one or more updates to current values of the respective parameters of the summarization neural network.

In some implementations, an auxiliary loss can be used (in addition to the temporal difference learning loss) to train the summarization neural network to improve its modeling of long term dependencies over transitions included in a given trajectory. In some of these implementations, doing so can involve determining an auxiliary loss that is based on a quality measure of the first and second encoded representations of the transitions, and then using the auxiliary loss to determine an update to the current values of the parameters of the summarization neural network.

The goal of the auxiliary loss is to encourage the first and second encoded representations generated for different transitions to capture meaningful information that facilitates better RL agent control. For example, the auxiliary loss can either be a supervised loss, e.g., one of the losses described in Jaderberg, M., et al., Reinforcement learning with unsupervised auxiliary tasks, arXiv preprint arXiv: 1611.05397, 2016, or a self-supervised loss, e.g., one of the losses described in Mazoure, B., et al., Deep reinforcement and infomax learning, arXiv preprint arXiv:2006.07217, 2020.

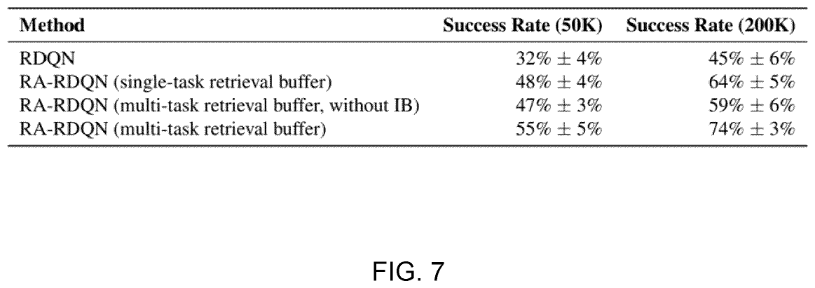

FIG. 7 shows a quantitative example of the performance gains that can be achieved by using the retrieval augmented agent control process described in this specification. Specifically, FIG. 7 shows a list of success rates achieved by an agent controlled using the neural network system 100 of FIG. 1 on environment navigation tasks with varying levels of difficulties selected from Chevalier-Boisvert, Maxime, et al. “Babyai: A platform to study the sample efficiency of grounded language learning.” arXiv preprint arXiv: 1810.08272 (2018). Success rate is defined as the ratio of tasks the agent was able to accomplish given a fixed number of steps for each task.

It can be appreciated that, each of (1) a retrieval-augmented recurrent DQN (RA-RDQN) with a multi-task replay buffer and with information bottleneck, (ii) a retrieval-augmented recurrent DQN (RA-RDQN) with a multi-task replay buffer and without information bottleneck, and (iii) a RA-RDQN with a replay buffer specific to the current task improves the performance of agent control over (iv) the baseline method of recurrent DQN (RDQN) (described in more detail in Hausknecht, Matthew, et al. “Deep recurrent q-learning for partially observable mdps.” 2015 aaai fall symposium series. 2015.) for varying amounts of offline training data (50K trajectories per task or 200K trajectories per task).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus tor implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for controlling a reinforcement learning agent in an environment to perform a task, the method comprising:
receiving a current observation characterizing a current state of the environment;
processing an encoder network input comprising the current observation using an encoder neural network to determine a policy neural network hidden state that corresponds to the current observation;
maintaining a plurality of trajectories generated as a result of the reinforcement learning agent interacting with the environment;
selecting one or more trajectories from the plurality of trajectories, comprising, for each of one or more attention slots:
applying a transition attention mechanism over the plurality of trajectories using one or more queries derived from the policy neural network hidden state that corresponds to the current observation to determine a respective trajectory attention weight for each trajectory, and
selecting one or more trajectories from the plurality of trajectories using the respective trajectory attention weights;
updating the policy neural network hidden state using update data determined from the one or more selected trajectories; and
processing the updated hidden state using a policy neural network to generate a policy output that specifies an action to be performed by the agent in response to the current observation.

2. The method of claim 1, wherein each trajectory comprises a sequence of transitions that each comprise a respective current observation characterizing a respective current state of the environment, and wherein the method further comprises:
for each of the one or more attention slots:
applying the transition attention mechanism over the sequences of transitions included in the one or more selected trajectories using one or more queries derived from the policy neural network hidden state that corresponds to the current observation to determine a respective transition attention weight for each transition included in the one or more selected trajectories, and
selecting one or more transitions from the one or more selected trajectories using the respective transition attention weights; and
wherein updating the hidden state comprises updating the hidden state using data from the one or more selected transitions.

3. The method of claim 1, wherein selecting the one or more trajectories from the plurality of trajectories using the respective trajectory attention weight comprises:
selecting a predetermined number of trajectories that have the highest trajectory attention weights among the plurality of trajectories.

4. The method of claim 1, further comprising:
generating, using a value neural network and from the hidden state that corresponds to the current observation and the data from the one or more selected trajectories, a value output that represents a value of the environment being in the current state characterized by the current observation to performing the task.

5. The method of claim 1, wherein the encoder neural network is a recurrent encoder neural network that comprises one or more recurrent neural network layers.

6. The method of claim 1, wherein the encoder neural network is part of the policy neural network.

7. The method of claim 1, wherein each attention slot has a corresponding recurrent neural network that is configured to:
receive as input the hidden state that corresponds to the current observation;
process the input to determine a recurrent neural network hidden state of the recurrent neural network that corresponds to the current observation; and
determine the one or more queries for the attention slot from the recurrent neural network hidden state.

8. The method of claim 7, further comprising, when the current state of the environment characterized by the current observation is a beginning state of the environment for the task:
determining, with some measure of randomness, an initial recurrent neural network hidden state for the respective recurrent neural networks for each of the attention slots.

9. The method of claim 2, further comprising, for each transition included in each trajectory:
generating, using a summarization neural network, a first encoded representation of the transition that summarizes the transition and other transitions that are before the transition in the sequence of transitions included in the trajectory; and
generating, using the summarization neural network, a second encoded representation of the transition that summarizes the transition and other transitions that are after the transition in the sequence of transitions included in the trajectory.

10. The method of claim 7, wherein determining the respective trajectory attention weight for each trajectory comprises determining the trajectory attention weight for the trajectory based on the respective transition attention weights for the transitions included in the trajectory.

11. The method of claim 7, wherein determining the respective transition attention weight for each transition included in the one or more selected trajectories comprises, for each of the one or more recurrent neural networks:
determining one or more transition keys from the first or second or both encoded representations of the transitions included in the trajectory; and
applying the transition attention mechanism over the sequences of transitions included in the one or more selected trajectories using the one or more transition keys and the one or more queries to determine the respective transition attention weight for each transition included in the one or more selected trajectories.

12. The method of claim 8, further comprising updating the respective recurrent neural network hidden state of each recurrent neural network based on determining update data from (i) the respective transition attention weight for each transition included in the one or more selected trajectories and (ii) the first or second or both encoded representations of each transition included in each trajectory.

13. The method of claim 12, further comprising regularizing the update data using an information bottleneck.

14. The method of claim 12, wherein updating the respective recurrent neural network hidden state of each recurrent neural network further comprises using data retrieved using a network hidden state self-attention mechanism from other network hidden states to determine the update to the respective network hidden state.

15. The method of claim 14, wherein updating the respective recurrent neural network hidden state of each recurrent neural network layer the network hidden state self-attention mechanism comprises, for each of one or more of the recurrent neural networks:
determining one or more hidden state queries from the respective network hidden state of the recurrent neural network;
applying the network hidden state self-attention mechanism over the respective network hidden states of one or more recurrent neural networks using the one or more hidden state queries to determine a respective hidden state attention weight for the respective network hidden state of each of the one or more recurrent neural networks; and
determining the update for the respective network hidden state of the recurrent neural network from (i) the hidden state attention weight for the respective network hidden state of each of the one or more recurrent neural networks and (ii) the respective network hidden state of each of the one or more recurrent neural networks.

16. The method of claim 12, wherein updating the hidden state using data from the one or more selected trajectories comprises:
determining an update to the hidden state from the update data, comprising applying a policy neural network hidden state attention mechanism over the update data using one or more queries derived from the hidden state.

17. The method of claim 1, further comprising training the policy neural network through reinforcement learning.

18. The method of claim 17, wherein training the policy neural network through reinforcement learning comprise:
determining a temporal difference learning loss associated with the current observation; and
determining, based on a gradient of the temporal difference learning loss computed with respect to a plurality of parameters of the policy neural network, an update to the values of the plurality of parameters of the policy neural network.

19. The method of claim 17, wherein during training the encoder network input further comprises a current action performed by the agent in response to the current observation and a reward received in response to the agent performing the current action.

20. The method of claim 17, further comprising backpropagating the gradient of the temporal difference learning loss into the recurrent neural networks to determine an update to current values of a respective plurality of parameters of each of the one or more recurrent neural networks.

21. The method of claim 17, further comprising:
determining an auxiliary loss that is based on a quality measure of the first and second encoded representations of the transitions; and
using the auxiliary loss to determine an update to current values of a plurality of parameters of the summarization neural network.

22-24. (canceled)

25. One or more computer-readable storage media storing instructions that when executed by one or more computers cause the one or more computers to perform operations for controlling a reinforcement learning agent in an environment to perform a task, wherein the operations comprise:
receiving a current observation characterizing a current state of the environment;
processing an encoder network input comprising the current observation using an encoder neural network to determine a policy neural network hidden state that corresponds to the current observation;
maintaining a plurality of trajectories generated as a result of the reinforcement learning agent interacting with the environment;
selecting one or more trajectories from the plurality of trajectories, comprising, for each of one or more attention slots:
applying a transition attention mechanism over the plurality of trajectories using one or more queries derived from the policy neural network hidden state that corresponds to the current observation to determine a respective trajectory attention weight for each trajectory, and
selecting one or more trajectories from the plurality of trajectories using the respective trajectory attention weights;
updating the policy neural network hidden state using update data determined from the one or more selected trajectories; and
processing the updated hidden state using a policy neural network to generate a policy output that specifies an action to be performed by the agent in response to the current observation.

26. A system comprising one or more computers and one or more storage devices storing instructions that when executed by one or more computers cause the one or more computers to perform operations for controlling a reinforcement learning agent in an environment to perform a task, wherein the operations comprise:
receiving a current observation characterizing a current state of the environment;
processing an encoder network input comprising the current observation using an encoder neural network to determine a policy neural network hidden state that corresponds to the current observation;
maintaining a plurality of trajectories generated as a result of the reinforcement learning agent interacting with the environment;
selecting one or more trajectories from the plurality of trajectories, comprising, for each of one or more attention slots:
applying a transition attention mechanism over the plurality of trajectories using one or more queries derived from the policy neural network hidden state that corresponds to the current observation to determine a respective trajectory attention weight for each trajectory, and
selecting one or more trajectories from the plurality of trajectories using the respective trajectory attention weights;
updating the policy neural network hidden state using update data determined from the one or more selected trajectories; and
processing the updated hidden state using a policy neural network to generate a policy output that specifies an action to be performed by the agent in response to the current observation.
